(19) United States
(12) Patent Application Publication
(10) Pub. No.: US 2016/0275521 A1
(43) Pub. Date: Sep. 22, 2016

(54) INTEGRATED ELECTRONIC WARRANTY PLATFORM

(71) Applicant: Warrantx, Inc., Trabuco Canyon, CA (US)

(72) Inventors: Mohammad Javad AFSHAR, Trabuco Canyon, CA (US); Behzad TORKIAN, Lexington, SC (US); Mark J. NUOVO, Irvine, CA (US)

(21) Appl. No.: 15/074,858

(22) Filed: Mar. 18, 2016

Related U.S. Application Data
(60) Provisional application No. 62/135,534, filed on Mar. 19, 2015.

(51) Int. Cl. G06Q 30/00; G06Q 30/02

(52) U.S. Cl. CPC G06Q 30/012; G06Q 30/0255

(57) ABSTRACT

Described herein is an integrated electronic warranty platform. An integrated electronic warranty platform provides automated features including servicing, tracking, and settling warranties. In addition, an integrated electronic warranty platform is configured to provide targeted advertisement to a consumer, as well as an extended warranty marketplace.

### PRIORITY

This patent application claims priority to U.S. Provisional Patent Application No. 62/135,534, filed on Mar. 19, 2015.

### BACKGROUND

Manufacturers and retailers often provide warranties to consumers of the products that they manufacture and sell. Warranties may provide for repair or exchange services free of charge to the consumer should the product fail to operate properly. The product warranty that is offered to the consumer is typically intended to instill confidence in the consumer in the quality of the product as well as the degree to which the manufacturer and seller provide product support post purchase. In this way, product warranties are intended to provide an incentive to consumers to purchase the product that is covered by the warranty.

Typically, consumer and product information must be provided to the issuer of the product warranty (e.g. the manufacturer or retailer) at or around the time of purchase of the product. For example, a manufacturer of a washing machine that provides a warranty on that product will need identifying information relating to the specific washing machine (e.g. a product serial number), the date of sale, and the name and contact information of the consumer of the product in order to fully servicing, settling, and tracking the warranty provided for the washing machine. In certain instances, at least some of the information needed to service, settle, and track a warranty must be supplied by the consumer.

### SUMMARY

Traditional warranty tracking is cumbersome for warranty providers or warranty settlers and consumers alike, and as a result, information necessary for generating, servicing, tracking, and settling warranties is not efficiently shared or in some traditional systems typically not shared at all. Warranty utilization is typically very low in the traditional system, and many consumers do not interact with product warranties at all.

Described herein is an integrated electronic warranty platform comprising of one or more servers each providing one or more server applications for providing integration of an electronic warranty. An integrated electronic warranty platform provides, for example, seamless servicing, tracking, and settling of warranties. In addition, an integrated electronic warranty platform provides for other features that result from integration of warranty information including an electronic warranty marketplace and directed consumer advertising.

Described herein is an integrated electronic warranty platform that is configured to provide or facilitate servicing of a warranty. Non-limiting examples of warranty servicing features provided by the integrated electronic warranty platform described herein include: the process of generating an electronic warranty; the process of efficiently and seamlessly associating an electronic warranty with a specific product and a specific consumer of said product; the process of storing and organizing electronic warranties associated with specific products that are in turn associated with specific consumers of said products; the process of providing a start date to an electronic warranty in accordance with the warranty policy (typically the time of purchase of the product by the recipient of the warranty); the process of providing additional product informational materials such as manuals; the process of providing notices to the consumer related to the product including, for example, notices of recall or available upgrades, and the processes of providing efficient channels of communication between one or more of the warranty servicer, the manufacturer of the product, the seller, and the consumer. Non-limiting examples of benefits provided by the warranty servicing as provided by the integrated electronic warranty platform as described herein include: seamless integration of necessary information to generate an electronic warranty, which vastly increases warranty utilization; accurate determination of the term of an electronic warranty, which provides certainty to warranty providers (or warranty settlers) and warranty holders; providing notices to consumers provides information that enhances the use of the product and in certain cases provides warnings that prevent injury or harm to property; and efficient communication amongst warranty providers (or warranty settlers) and holders provides consumer satisfaction.

Described herein is an integrated electronic warranty platform that is configured to provide one or more of a manufacturer, retailer, and electronic payment provider the ability to track product related data. Non-limiting examples of tracking related features provided by the integrated electronic warranty platform include: tracking of warranty claims associated with a specific consumer; tracking of warranty claims associated with a specific manufacturer; tracking of warranty claims associated with a specific product; tracking of warranty claims associated with a specific seller; tracking of the absolute number of warranty claims made; tracking the number of warranty claims settled; tracking the products purchased by a consumer; tracking the sellers from which a consumer purchases products; and tracking the form of electronic payment used by a consumer to purchase a product. Non-limiting examples of electronic payment providers include a credit card or debit card provider, Paypal®, the Apple Pay® application, an Android Pay application, and wireless payment transfer providers. Non-limiting examples of advantages provided by the integrated electronic warranty platform as described herein include: tracking product malfunction rates (based on warranty claims) guides sellers in terms of which products to carry; tracking the number of warranty claims made on a particular product provides a proxy for consumer satisfaction or dissatisfaction with a product; the ability to track numerous warranty claims made on a particular product manufactured at a particular plant allows manufacturers to locate and address a specific shortcoming in their manufacturing process; certain consumer demographic and purchase data is available based on the warranties associated with those particular consumers that are used by one or more of manufacturers, sellers, and electronic payment providers in terms of product marketing; and tracking the types of electronic payment type used by certain consumers to purchase certain products provides marketing data to the electronic payment provider.

Described herein is an integrated electronic warranty platform that is configured to provide or facilitate settlement of a warranty. Non-limiting examples of settlement related features provided by the integrated electronic warranty platform include: communicating claims from a warranty holder to a warranty provider; determining expiration of warranty term relative to the claim; determining if a servicer of a warranty differs from the warranty provider and communicating the claim to the proper servicer; identifying to the warrant provider consumers of a product under recall; offering an extended warranty marketplace; and providing a claim dispute process. Non-limiting examples of advantages provided by the integrated electronic warranty platform as described herein include: facilitating efficient settlement of warranties; providing warranty extension; and providing consumer's the ability to dispute a refusal to honor a warranty (e.g. by connecting the consumer with an attorney).

In some embodiments, the extended warranty marketplace comprises an auction, wherein consumers are able to bid on extended warranty offers.

Described herein is warranty claim settlement platform, comprising: a local processor configured to provide a local application to the consumer of the product, the local application comprising: a software module for providing an interface for viewing an electronic warranty that is associated with an identifier of a product and an identity of the consumer, for creating a warranty claim, and for transmitting the warranty claim to the remote processor; and a remote processor configured to provide a remote application, comprising: a software module for receiving the identifier of the product, for receiving the identity of the consumer of the product, and for associating the electronic warranty with the identifier of the product and with the identity of the consumer of the product; a software module for receiving the warranty claim from the consumer of the product, for transmitting the warranty claim to a warranty settler, and for tracking a settlement of the warranty claim by the warranty settler. In some embodiments, the identifier of the product comprises a product serial number. In some embodiments, the identity of the consumer of the product comprises one or more of the name, address, email address, and telephone number of the consumer of the product. In some embodiments, the remote application comprises a software module for receiving a transmission from a seller of the product, and wherein the identity of the consumer of the product is transmitted to the remote processor by the seller. In some embodiments, the remote application comprises a software module for receiving a transmission from an electronic purchase provider, and wherein the identity of the consumer of the product is transmitted to the remote processor as part of a purchase by the electronic payment provider. In some embodiments, the remote application comprises a software module for generating the electronic warranty. In some embodiments, generating the electronic warranty comprises adding a warranty start date to an electronic warranty template. In some embodiments, the remote application comprises a software module for receiving the electronic warranty from a manufacturer of the product. In some embodiments, the remote application comprises a software module for generating a digital-life identity for the consumer based on one or more of a type of the product purchased by the consumer, a price of the product purchased by of the consumer, a location where the consumer owns a residence, and an income of the consumer. In some embodiments, the remote application comprises a software module for communicating the digital-life identity to one or more of the manufacturer of the product, the seller of the product, an electronic payment provider, and the consumer of the product. In some embodiments, the remote application comprises a software module for generating a directed advertisement based on the digital-life identity. In some embodiments, the local application comprises a software module for displaying the directed advertisement using the interface. In some embodiments, the local processor comprises a mobile computing device. In some embodiments, the local application comprises a software module for managing the electronic warranty using the interface. In some embodiments, the local application comprises a software module for generating the electronic warranty. In some embodiments, the electronic warranty is generated using a digital scanner to convert a printed warranty to the electronic warranty. In some embodiments, the electronic warranty is generated using a digital camera to convert a printed warranty to the electronic warranty. In some embodiments, the local application comprises a software module for generating an identifier of the product. In some embodiments, the identifier of the product is generated using a barcode reader to read a barcode associated with the product. In some embodiments, the remote application comprises a software module for generating an electronic extended warranty marketplace, and wherein the local application comprises a software module for purchasing an extended warranty from the electronic extended warranty marketplace using the interface.

Described herein is a computer-implemented method for settlement of a warranty comprising: receiving an identifier of a product; receiving an identity of a consumer of the product; associating an electronic warranty for the product with the identifier of the product and with the identity of the consumer of the product; receiving a warranty claim from the consumer of the product; communicating the warranty claim to a warranty settler; tracking a settlement of a warranty settler; and wherein the warranty settler settles the warranty claim with the consumer of the product in response to receiving the electronic warranty claim from the remote processor. In some embodiments, the identifier of the product comprises a product serial number. In some embodiments, the identity of the consumer who purchased the product comprises one or more of the name, address, email address, and telephone number of the consumer of the product. In some embodiments, the method comprises receiving a transmission from a seller of the product, and wherein the identity of the consumer of the product is transmitted to the remote processor by the seller. In some embodiments, the method comprises receiving a transmission from an electronic payment provider, and wherein the identity of the consumer of the product is transmitted to the remote processor by the electronic payment provider. In some embodiments, the method comprises generating the electronic warranty. In some embodiments, generating the electronic warranty comprises adding a warranty start date to an electronic warranty template. In some embodiments, the method comprises receiving the electronic warranty from the manufacturer of the product. In some embodiments, the method comprises generating a digital-life identity for the consumer based on one or more of a type of the product purchased by the consumer, a price of the product purchased by of the consumer, a location where the consumer owns a residence, and an income of the consumer. In some embodiments, the method comprises communicating the digital-life identity to one or more of the manufacturer of the product, the seller of the product, an electronic payment provider, and the consumer of the product. In some embodiments, the method comprises generating a directed advertisement based on the digital-life identity. In some embodiments, the method comprises displaying the directed advertisement to the consumer of the product. In some embodiments, the method comprises transmitting the electronic warranty to a mobile computing device of the consumer of the product. In some embodiments, the method comprises managing the electronic warranty based on an instruction received from a computing device of the consumer of the product. In some embodiments, the method comprises receiving the electronic warranty from a digital device of the consumer of the product. In some embodiments, the digital device comprises a digital camera. In some embodiments, the method comprises receiving the identifier of the product from a digital device of the consumer of the product. In some embodiments, the digital device comprises a barcode reader. In some embodiments, the method comprises generating an electronic extended warranty marketplace. In some embodiments, the method comprises selling an extended warranty from the electronic extended warranty marketplace to the consumer of the product.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an embodiment of an integrated electronic warranty platform.

FIG. 2 shows an embodiment of an integrated electronic warranty platform.

FIG. 3 shows a schematic of an embodiment of a database of an integrated electronic warranty platform.

FIG. 4 shows a schematic representation of an embodiment of a user interface of an integrated electronic warranty platform.

FIG. 5 shows an embodiment of a graphic user interface of an integrated electronic warranty platform that is provided to a consumer.

FIG. 6 shows a schematic of integrated electronic warranty platform features including warranty claim settlement, directed advertisement, and an extended warranty marketplace.

FIG. 7 shows a process for generation of an electronic warranty.

### DETAILED DESCRIPTION

Described herein is an integrated electronic warranty platform. An integrated electronic warranty platform comprises one or more servers each providing one or more server applications for providing integration of features and data for the utilization of an electronic warranty. An integrated electronic warranty platform provides, for example, seamless servicing, tracking, and settling of warranties. In addition, an integrated electronic warranty platform provides for other features that result from integration of warranty information including an electronic warranty marketplace and directed consumer advertising.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, or stylus. In some embodiments, the input device is a touch screen or a multi-touch screen. In other embodiments, the input device is a microphone to capture voice or other sound input. In other embodiments, the input device is a video camera or other sensor to capture motion or visual input. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, and Samsung® Apps.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, Edge®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser. Web browsers may be configured to run the internet protocols such as, for example, the protocols known as http, ftp, and smtp.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

### Integrated Electronic Warranty Platform Architecture

An electronic warranty comprises an electronic document comprising one or more promises, assurances, or guarantees made by a provider of a warranty to a consumer of a product or a service for which the promise, assurance, or guarantee is made. It should be understood that a consumer may be an individual, group of individuals, or entity.

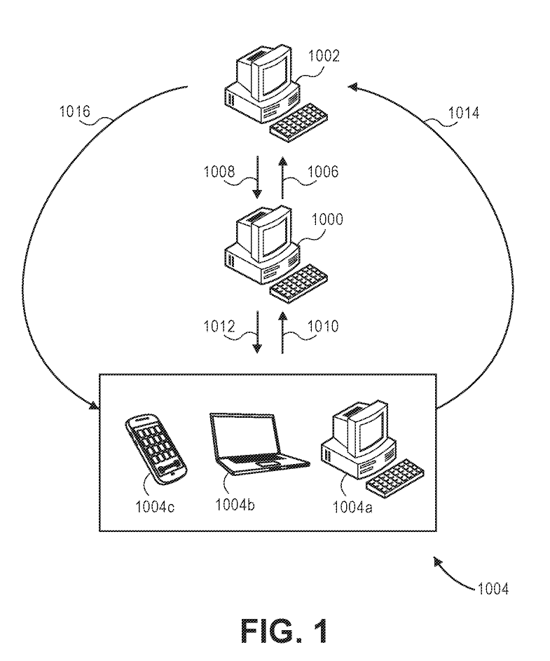

FIG. 1 shows an embodiment of an integrated electronic warranty platform. As shown the integrated electronic warranty platform comprises a first remote server 1000, a second remote server 1002, and a local server 1004, wherein the local server may comprise one or more of a desktop computer 1004a, a mobile computing device 1004b (e.g. a laptop or tablet), and a smartphone 1004c. The first remote server 1000 is configured to provide a server application that provides features used by an electronic warranty monitoring provider, the second remote server 1002 is configured to provide a server application that provides features used by a warranty provider or warranty settler such as, for example, a manufacturer of a product, and the one or more local servers 1004a-1004c are configured to provide one or more server applications that provide features used by a consumer of a product. A server application further comprises one or more software modules that provide one or more features to the respective users. It should be understood that the first remote server 1000 and the second remote server 1002 are “remote” from the perspective of the one or more local servers 1004a-1004c that are with a consumer. It should be further understood that numerous other computing devices are suitable for use with the platforms and methods described herein including wearable and implantable computing technologies.

The platform of FIG. 1 comprises of communication channels 1006, 1008, 1010, 1012, 1014, and 1016. Communication channels 1006, 1008, 1010, 1012, 1014, and 1016 may comprise any hardwire or wireless communication system or device for transferring data from one computing device to another. Communication channel 1006 is configured to transmit data from the first remote server 1000 to the second remote server 1002. Communication channel 1008 is configured to transmit data from the second remote server 1002 to the first remote server 1000. Communication channel 1010 is configured to transmit data from the one or more local servers 1004a-1004c to the first remote server 1000. Communication channel 1002 is configured to transmit data from the first remote server 1000 to the one or more local servers 1004a-1004c. Communication channel 1014 is configured to transmit data from the one or more local servers 1004a-1004c to the second remote server 1002. Communication channel 1016 is configured to transmit data from the second remote server 1002 to the one or more local servers 1004a-1004c. It should be understood that configurations of a platform in accordance with the platform described herein are possible without one or more of communication channels 1006, 1008, 1010, 1012, 1014, and 1016.

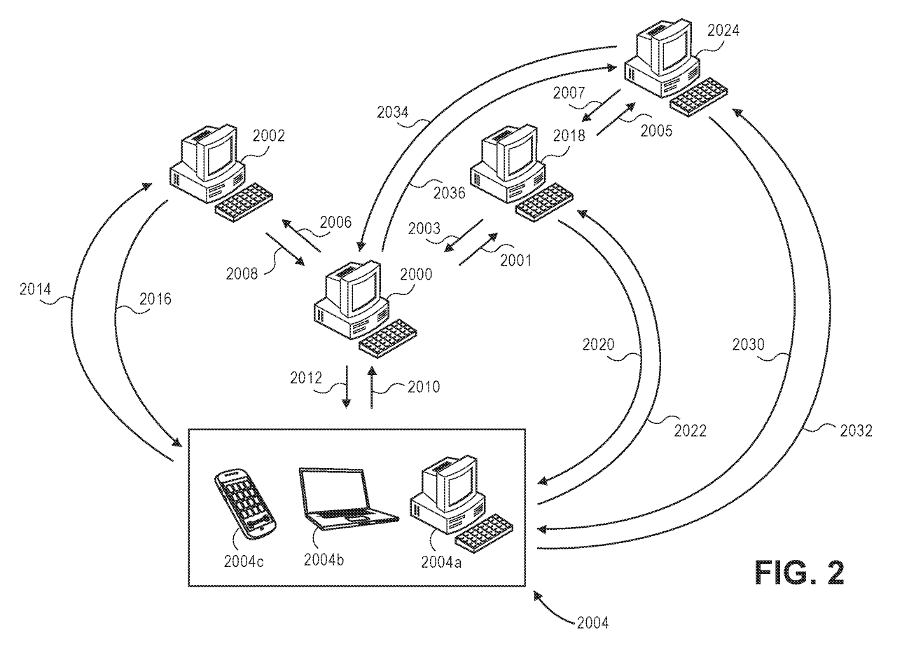

FIG. 2 shows an embodiment of an integrated electronic warranty platform. As shown the integrated electronic warranty platform comprises a first remote server 2000, a second remote server 2002, a third remote server 2018, a local server 2004, wherein the local server may comprise one or more of a desktop computer 1004a, a mobile computing device 1004b (e.g. a laptop or tablet), and a smartphone 1004c, and/or a fourth remote server 2024. That is, in some embodiments, the platform as shown in FIG. 2 includes both the third remote server 2018 and the fourth forth server 2024, in some embodiments, the platform includes the third remote server 2018 and not the fourth remote server 2024, and in some embodiments the platform includes the fourth remote server 2024 and not the third remote server 2018. The first remote server 2000 is configured to provide a server application that provides features used by an electronic warranty monitoring provider, the second remote server 2002 is configured to provide a server application that provides features used by a warranty provider or warranty settler such as, for example, a manufacturer of a product, the third remote server 2018 is configured to provide a server application that provides features used by a seller of a product, the fourth remote server 2024 is configured to provide a server application that provides features used by an electronic payment provider such as, for example a credit or debit card provider or online payment transfer provider, and the one or more local servers 2004a-2004c are configured to provide one or more server applications that provide features used by a consumer of a product. A server application further comprises one or more software modules that provide one or more features to the respective users. It should be understood that the four remote servers 2000, 2002, 2018, and 2024 are “remote” from the perspective of the one or more local servers 2004a-2004c that are with a consumer.

The platform of FIG. 2 comprises of communication channels 2001, 2003, 2005, 2006, 2007, 2008, 2010, 2012, 2014, and 2016, 2020, 2022, 2030, 2032, and 2036. Communication channels 2001, 2003, 2005, 2006, 2007, 2008, 2010, 2012, 2014, and 2016, 2020, 2022, 2030, 2032, and 2036 may comprise any hardwire or wireless communication system or device for transferring data from one computing device to another. Communication channel 2006 is configured to transmit data from the first remote server 2000 to the second remote server 2002. Communication channel 2008 is configured to transmit data from the second remote server 2002 to the first remote server 2000. Communication channel 2010 is configured to transmit data from the one or more local servers 2004a-2004c to the first remote server 2000. Communication channel 2002 is configured to transmit data from the first remote server 2000 to the one or more local servers 2004a-2004c. Communication channel 2014 is configured to transmit data from the one or more local servers 2004a-2004c to the second remote server 2002. Communication channel 2016 is configured to transmit data from the second remote server 2002 to the one or more local servers 2004a-2004c. Communication channel 2020 is configured to transmit data from the third remote server 2018 to the one or more local servers 2004a-2004c. Communication channel 2022 is configured to transmit data from the one or more local processors 2004a-2004c to the third remote server 2018. Communication channel 2030 is configured to transmit data from the forth remote server 2024 to the one or more local servers 2004a-2004c. Communication channel 2032 is configured to communicate data from the one or more local servers 2004a-2004c to the fourth remote server 2024. Communication channel 2001 is configured to transmit data from the first remote server 2000 to the third remote server 2018. Communication channel 2003 is configured to transmit data from the third remote server 2018 to the first remote server 2000. Communication channel 2005 is configured to transmit data from the third remote server 2018 to the fourth remote server 2024. Communication channel 2007 is configured to transmit data from the fourth remote server 2024 to the third remote server 2018. It should be understood that configurations of a platform in accordance with the platform described herein are possible without one or more of communication channels 2001, 2003, 2005, 2006, 2007, 2008, 2010, 2012, 2014, and 2016, 2020, 2022, 2030, 2032, and 2036.

In an alternative embodiment, server 2024 is configured to be used by a carrier of a product, such as, for example, UPS, FedEx, or US Mail.

### Integrated Electronic Warranty Platform Operation

In some embodiments, an electronic warranty monitoring platform comprises an automated clearinghouse for electronic warranties that, among other things, services, tracks, and settles warranties.

### Servicing of an Electronic Warranty

Servicing of an electronic warranty by the integrated electronic warranty platform comprises receiving of data from different platform members (e.g. second remote server 2000 and/or one or more of the local servers 2004a-2004c, and associating the received data with other received data.

In some embodiments, the first remote server 2000, which is configured to be used by an electronic warranty monitoring provider comprises a software module for receiving data comprising a unique identifier of a product that is transmitted from the second remote server 2002, which is configured to be used by a manufacturer, via communication channel 2008. Non limiting examples of unique product identifiers include serial numbers, product numbers, product codes, vehicle identification number (VIN), marks, colors, shapes, weights, and dimensions. For example, a manufacturer of a car transmits a VIN to the first server 2000 via communication channel 2008 using a server application provided by remote server 2002 that comprises a software module for transmitting data. In some embodiments, the server application provided by the first server 2000 comprises a software module for receiving an electronic warranty that is transmitted from the second remote server 2002 to the first remote server via channel 2008. For example, a manufacturer of a car transmits a VIN to the first server 2000 via communication channel 2008 as well as an electronic warranty that associated with the car for which the VIN was transmitted. For example, a manufacturer transmits a warranty template to first server 2000 via communication channel 2008, wherein the warranty template includes some elements of the electronic warranty but requires additional information to be added to complete. In some embodiments, an electronic warranty is generated by the first remote server 2000 in response to the receipt of the unique product identifier from the second remote server 2002.

In some embodiments, the server application provided by the first remote server 2000 which is configured to be used by an electronic warranty monitoring provider generates an electronic warranty from a template provided by the second remote server 2002 which is configured to be used by a manufacturer or other warranty provider or warranty settler. In some embodiments, first remote server 2000 comprises generates the electronic warranty by adding the warranty start date to an electronic warranty template. In some embodiments, the first remote server 2000 generates the electronic warranty by adding consumer information to an electronic warranty template.

In some embodiments, the first remote server 2000, which is configured to be used by an electronic warranty monitoring provider receives data from the one or more local servers 2004a-2004c which are configured to be used by a consumer of a product. In some embodiments, one or more local servers 2004a-2004c transmit a unique product identifier to the first remote server 2000 via communication channel 2010. In some embodiments, the one or more local servers 2004a-2004c receive a unique product identifier entered manually by the consumer by typing the identifier of a product through a keyboard, touchscreen, or graphic user interface. For example, a consumer of a microwave oven manually enters the serial number of the microwave oven into the mobile computing device 2004b, and mobile computing device 2004b transmits the serial number of the microwave oven to the first remote server 2000 via communication channel 2010. In some embodiments, the one or more servers 2004a-2004c receive a digital picture of the serial number of a product, such as from, for example, a camera integrated with the smartphone 2004c. In some embodiments, the one or more local servers 2004a-2004c receive a product serial number from a barcode reader, such as, for example, a barcode reader application that is provided as part of the server application. In some embodiments, the one or more local servers 2004a-2004c comprise a software module for receiving an electronic warranty, such as, for example, from a document scanner application. The one or more local servers 2004a-2004c are configured to receive consumer identifying information. Non-limiting examples of consumer identifying information include the consumer's name, home address, email address, and telephone number. In this embodiment, the consumer enters identifying information through typing, speaking, or writing the information with any known or described method for entering electronic data into a computing device. In these embodiments, the one or more server applications provided by the one or more local servers 2004a-2004c comprise a software module configured to transmit one or more of a unique product identifier, an electronic warranty, and consumer identifier via communication channel 2012 to the first remote server 2000 and/or via communication channel 2014 to the second remote server.

In some embodiments, the first remote server 2000, which is configured to be used by an electronic warranty monitoring provider comprises a software module for receiving data comprising one or more of a product identifier data, warranty data, and consumer identifier data from the third remote server 2018, which is configured to be used by a seller of a product purchased by the consumer. In some embodiments, a unique product identifier of a product sold by the seller to a consumer is transmitted from the third remote sever 2018 which is configured to be used by the seller to the first remote server 2000 which is configured to be used by an electronic warranty monitoring provider at the time of the sale of the product to the consumer. In some embodiments, the third remote server 2018 which is configured to be used by a seller similarly transmits an electronic warranty associated with the product purchased by the consumer to the first remote processor 2000.

In some embodiments, a seller receives one or more consumer identifiers comprising a consumer name, a consumer address, a consumer email address, and a consumer telephone number from a consumer making a purchase. In some embodiments, the consumer transmits one or more identifiers from the one or more local servers 2004a-2004c to the third remote server 2018 which is configured to be used by a seller during, for example, an on-line e-commerce transaction. In some embodiments, a consumer provides one or more identifiers to a sensor manually or verbally. In some embodiments, one or more consumer identifiers are automatically transferred from a credit or debit card as part of a payment transaction. In some embodiments, one or more consumer identifiers are transmitted from the fourth remote server 2024 which is configured to be used by an electronic payment provider, to the third remote server 2018 which is configured to be used by a seller via communication channel 2005. For example, John Smith purchases a toaster at Store X, and Store X transmits John Smith's name, address, and telephone number to the first remote server 2000 which is configured to be used by an electronic warranty monitoring service.

In some embodiments, the first remote server 2000 which is configured to be used by an electronic warranty monitoring provider comprises a software module for receiving data from the fourth remote server 2024 which is configured to be used by an electronic payment provider, wherein the data is transmitted via channel 2010. In this embodiment, the electronic payment provider transmits one or more consumer identifiers to the first remote server 2000.

### Associating Data

Servicing of an electronic warranty by the first remote server 2000 comprises associating a received unique product identifier with an electronic warranty and further associating the unique product and associated warranty with a consumer of the unique product. The first remote server 2000 associates data received from other platform elements so that a consumer identifier is associated with the product that they purchased and the warranty that is provided with that product. For example, a consumer, John Smith, purchases a refrigerator manufactured by Company Alpha. As described herein, in some embodiments, either the consumer, the seller, or an electronic payment provider transmits one or more consumer identifiers, such as the consumer's name, John Smith, to the first remote processor 2000 used by an electronic warranty monitoring provider. Also as described herein, in some embodiments, either the consumer, the seller, or the manufacturer transmits the refrigerator serial number 12345 of the purchased refrigerator and/or the 10 year warranty provided with the purchased refrigerator to the first remote server 2000 used by the electronic warranty monitoring provider. The first remote server 2000 receives consumer identifier, John Smith, with the serial number 12345 and the 10 year warranty that is provided by Company Alpha for the refrigerator. The associated data is then stored in a database.

The first server processor 2000 which is configured to be used by an electronic warranty monitoring provider associates additional products and warranties with the same consumer. The first remote server 2000 is configured to associate a plurality of products and their respective warranties with a single consumer. Thus, for example, John Smith is associated with a car having VIN 54321 and the bumper-to-bumper warranty that is provided with that car in addition to the refrigerator having serial number 12345 and the 10 year warranty provided by Company Alpha. It should be understood that a warranty covering a product may be provided by a party that is not the manufacturer of the product, and the server application of the first remote server 2000 is configured to associate that warranty as well.

In addition, the first remote server 2000 is configured to disassociate one or more of a previously associated unique product identifier, an electronic warranty associated with said product, and a consumer identifier. Thus, when, for example, consumer transfers ownership of a product to another person or entity the consumer is no longer associated with the product and warranty. If the transfer did not invalidate the non-expired warranty, the recipient of the product from the transferring consumer, and in some embodiments, the first remote server 2000 comprises software for verifying that a warranty remains valid following a transfer. Similarly, a consumer is disassociated from an electronic warranty when the term of the electronic warranty is expired. In some embodiments, the first remote server 2000 determines when an electronic warranty has expired and disassociates a product and a consumer from that expired electronic warranty. In some embodiments, the first remote server 2000 transmits a notification to the consumer and/or manufacturer via communication channels 1012 and 2006 respectively when an electronic warranty is expired. In some embodiments, a manufacturer notifies a consumer regarding the expiration of a manufacturer provided electronic warranty via communication channel 2016.

### Tracking of an Electronic Warranty

Tracking of an electronic warranty by the first remote server 2000 comprises analyzing warranty claim related data. Non-limiting examples of types of data tracked by an electronic warranty monitoring platform include manufacturer data, seller data, electronic payment provider data, and consumer data.

### Manufacturer Data

In some embodiments, tracking of manufacturer data comprises analysis of data associated with one or more products manufactured by said manufacturer and/or one or more warranties provided by said manufacturer. Non-limiting examples of product data includes the number of warranties provided by the manufacturer in total on all of their products taken together, the number of warranties provided on a particular product, the length of term of a warranty provided for one or more products by a manufacturer, the terms of a warranty (e.g. replacement vs. repair, preconditions) provided by a manufacturer, the number of total warranty claims against a manufacturer, the number of warranty claims settled by the manufacturer, the time from initiation of a warranty claim to its settlement, the number of settlements that comprised 100% of the warranty coverage and the number of settlements that did not, and the number of warranty claims associated with a specific plant or person. In some embodiments, when a mass recall occurs an electronic warranty monitoring platform generates a list of all consumers affected, and in some embodiments, an electronic warranty monitoring platform notifies the consumers affected of the recall. In some embodiments, an electronic warranty monitoring platform monitors the progress of the recall.

In some embodiments, an electronic warranty monitoring platform generates a data model relating to a manufacturer. Predictions of manufacturer behavior are predicted based on data associated with the manufacturer and other similar manufacturers through machine learning algorithms. For example, if a first manufacturer of a product provides a discount to consumers on a product it is predicted that price drops will occur for products made by data matched manufacturers. In some embodiments, notices are sent to consumer and/or seller users of the platform regarding the generated predictions. In some embodiments, social media data regarding a manufacturer is used to determine data relating to a manufacturer. For example, in some embodiments, if a manufacturer receives negative reviews on social media or consumer review websites, the electronic warranty monitoring platform notifies a consumer who either purchased the product or is predicted to have interest in the product. In some embodiments, an electronic warranty monitoring platform notifies a consumer of a product if a certain threshold number of warranty claims are made on the product within a certain time period.

### Seller Data

In some embodiments, tracking of seller data comprises analysis of data associated with one or more products sold by a seller. Non-limiting examples of seller data include the number of a particular product sold by a seller, the number of warranties associated with products sold by the seller, and the number of warranty claims made on products sold by the seller.

In some embodiments, an electronic warranty monitoring platform generates a data model relating to a seller. Predictions of seller behavior are predicted based on data associated with the seller and other similar manufacturers through machine learning algorithms. For example, if a first seller of a product provides a discount to consumers on a product it is predicted that price drops will occur for the same or similar products sold by data matched seller. In some embodiments, notices are sent to consumer users of the platform regarding the generated predictions. In some embodiments, social media data regarding a seller is used to determine data relating to a seller. For example, in some embodiments, if a seller receives negative reviews on social media or consumer review websites, the electronic warranty monitoring platform notifies a consumer who either purchased a product from the seller or is predicted to have interest in the seller based on, for example, the location of the seller relative to the home address of the consumer.

### Electronic Payment Provider Data

In some embodiments, tracking of electronic payment provider data comprises analysis of electronic payment data. Non-limiting examples of electronic payment data include, the type of products purchased with a particular type of electronic payment, the number of products purchased with electronic payment, the prices of products purchased with electronic payment, and the types of electronic payment used by a particular consumer.

### Consumer Data

In some embodiments, tracking of consumer data comprises analyzing received warranty claims. Non-limiting examples of analysis of warranty claims provided by the first remote server 2000 include the overall number of warranty claims over a period of time, the number of warranty claims made on a particular product or type of product, the number of warranty claims settled by a warranty provider or warranty settler (e.g. a manufacturer), the number of warranty claims associated with a product manufactured at a particular plant or by a particular person, the number of warranty claims made by a particular demographic of consumers or by a particular consumer, and the number of warranty claims associated with products sold from a particular seller or distributor.

In some embodiments, an electronic warranty monitoring platform does one or more of generating, storing, analyzing, and modifying a digital-life identity of a consumer. In some embodiments a digital-life identity of a consumer comprises conclusions and/or predictions derived from analysis of the behavior of a consumer. In some embodiments, a digital-life identity comprises conclusions and/or predictions derived from analysis of factors that may affect a consumer.

In some embodiments, a digital-life identity of a consumer comprises a one or more dimensional data model.

In some embodiments, statistical analysis is used to extrapolate behaviors of a consumer based on data associated with the consumer that is provided to the electronic warranty monitoring provider. Data provided to the electronic warranty monitoring provider is provided to the electronic warranty monitoring provider from one or more of a consumer (providing data relating to the consumer or a different consumer), a manufacturer, a seller, an electronic payment provider, social media, open data sources, and public records.

In an exemplary embodiment of an electronic warranty monitoring platform, a consumer enters a home address. The exemplary electronic warranty monitoring platform searches public records and confirms that the consumer who entered the home address is the owner of record of the home corresponding to the address. The exemplary electronic warranty monitoring platform searches public records to determine the amount the consumer paid for the property. Based on the amount paid for the home by the consumer, the exemplary electronic warranty monitoring platform determines or extrapolates the income of the consumer. An extrapolation of the income of a user from the cost of the users home is an example of the determination of a factor that may affect a consumer and is stored as part of the digital-life identity of the consumer.

Non-limiting examples of other data provided to an electronic warranty monitoring provider and included in an electronic warranty monitoring platform under the digital-life identity of a consumer include the number of cars owned by the user based on Department of Motor Vehicle records, the climate in which the consumer lives (based on their address), and the marital status of the consumer (if the consumer is an individual) based on public records.

In an exemplary embodiment of an electronic warranty monitoring platform, consumer habit behavior is determined from products and/or services purchased by the consumer, wherein the data used is data tracked by the electronic warranty monitoring platform as described herein. For example, a consumer who purchase expensive products relative to their predicted earnings is determined to not have the habit of saving their earnings.

In an exemplary embodiment of an electronic warranty monitoring platform, the digital-life identity of a consumer is used to generate targeted communications and/or advertisements to a consumer. For example, knowing that a consumer lives in an environment in which it snows for much of the year leads to generation of a targeted advertisement for automobiles having four wheel drive systems when the platform determines that the warranty on the consumer's current car has expired. For example, knowing the consumer's spending habits relative to their extrapolated income leads to the generation of a targeted advertisement for a product within a particular price range.

In some embodiments, an electronic warranty monitoring platform comprises one or more machine learning algorithms. In some embodiments, a machine learning algorithm uses consumer data including, for example, on or more of data related to the consumer, consumer earning data, consumer purchasing data, and consumer habit data to predict a behavior or interest of the consumer. In some embodiments, a machine learning algorithm uses consumer data including, for example, on or more of data related to the consumer, consumer earning data, consumer purchasing data, and consumer habit data to predict a behavior or interest of a different user. For example, when a similarly situated or data-matched group of consumers makes a particular purchase, the purchase is suggested to the consumer when it is determined that the consumer has not already purchased said product or service. Machine learning algorithms are also configured to compare actual data with predicted data to improve subsequent predictions.

In some embodiments, an electronic warranty monitoring platform creates indexes for analyzing and/or predicting consumer habits, interests, and/or behaviors. For example, a spending index comprises a ratio of the extrapolated income of a consumer relative to the amount spent on purchased products over a period of time. Comparing consumers with similar spending indexes is used to create predictions with regards to the types of products and price ranges of said products that interest matched consumers.

### Settling Warranty Claims

Settling warranty claims comprises either directly settling the warranty claim or facilitating the settlement of the claim.

The one or more local servers 2004a-2004c provide a consumer the ability to enter a claim on a warranty for a purchased product. The warranty claim is transmitted to the first remote server 2000 via communication channel 2010 as described herein. In some embodiments, a warranty claim received from the one or more local servers 2004a-2004c is transmitted from the first remote server 2000 which is configured to be used by the electronic warranty monitoring provider, directly to the second remote server 2002 which is configured to be used by the manufacturer or other warranty provider or warranty settler. In some embodiments, the electronic warranty monitoring provider settles the warranty claim directly on behalf of the warranty provider or warranty settler by, for example, replacing a defective product covered by a valid warranty. In some embodiments, if a warranty found to be valid is not settled by the warranty provider or warranty settler, the electronic monitoring provider provides a dispute process for the consumer who entered the claim to dispute the failure of the service provider to settle the claim. For example, in some embodiments, a first remote server 2000 is configured to connect a consumer with an attorney or arbitrator who specializes in this area of law.

### Integrated Electronic Warranty Platform Database

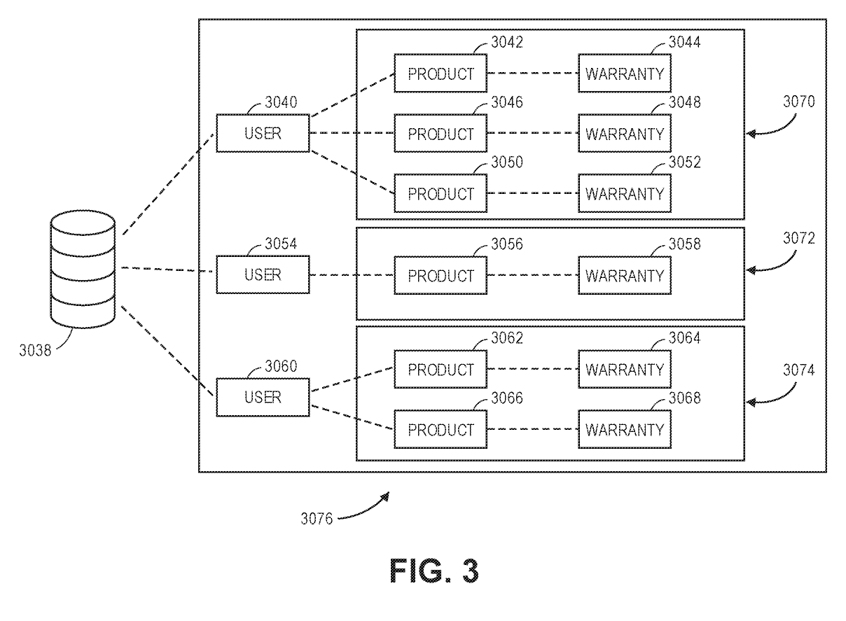

FIG. 3 shows a schematic of an embodiment of a database 3038 of an integrated electronic warranty platform. The database 3038 stores data that is connected in numerous different ways. As shown, the database stores user information comprising users 3040, 3054, and 3060 of the integrated electronic warranty platform. A user of the platform comprises any of a consumer, a manufacturer, a seller, and electronic payment provider. For example, user 3040 comprises seller, Store X, user 3054 comprises manufacturer, Company Alpha, and user 3060 comprises consumer, John Smith. Each user is associated with user data 3070, 3072, and 3074. User data 3070 comprises product 3042 associated with electronic warranty 3044, product 3046 associated with warranty 3048, and product 3050 associated with warranty 3052. User data 3070 is associated with user 3040. Thus in the above example, Store X is associated with data relating to products sold by Store X along with accompanying warranties stored as user data 3040. As described, this does not necessarily mean that the user data 3070 was transmitted by the seller to the database as in the integrated electronic warranty platform there are multiple different sources of this data. Also, as described other seller data is also stored as user data 3070. Similarly, in the above example, user 3054, Company Alpha, is associated with user data 3072 comprising a single product 3056 associated with a single warranty 3058. As described, this does not necessarily mean that the user data 3072 was transmitted by the manufacturer to the database as in the integrated electronic warranty platform there are multiple different sources of this data. Also, as described other manufacture data is also stored as user data 3072. Similarly, in the above example, user 3054, John Smith, is associated with user data 3074 comprising two products 3062 and 3066 respectively associated with two warranties 3064 and 3068. As described, this does not necessarily mean that the user data 3074 was transmitted by the consumer to the database as in the integrated electronic warranty platform there are multiple different sources of this data. Also, as described other consumer data is also stored as user data 3072.

Database 3038 further stores other data that is associated with a user, and/or product, and/or warranty stored in the database. Non-limiting examples of data stored in database 3038 includes product manuals, user guides, schematic diagrams, coupons, summaries, trouble shooting guides, as well as data that is specific to a user including a consumer, a manufacturer, a seller, a third party warranty provider or warranty settler, and an electronic payment provider.

### Integrated Electronic Warranty Platform User Interface

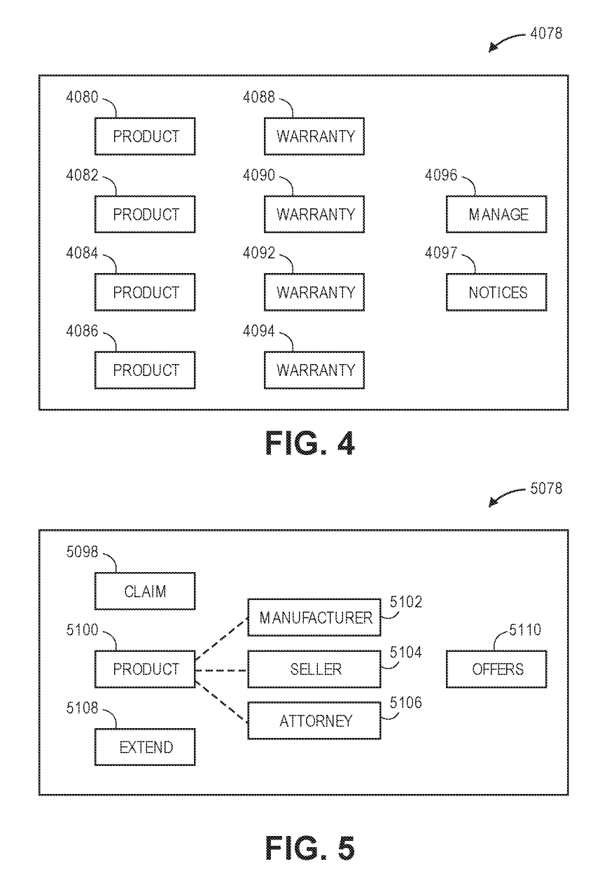

FIG. 4 shows a schematic representation of an embodiment of a user interface 4078 of an integrated electronic warranty platform. A user interface 4078 is provided via a server processor to one or more members of the integrated electronic warranty platform comprising a manufacturer, a seller, a consumer, and an electronic payment provider. In some embodiments, the user interface 4078 comprises a graphic user interface. As shown, the user interface 4078 displays a number of different products 4080, 4082, 4084, and 4086 along with warranty 4088, 4090, 4092, and 4094, as well as a manage button 4096 and a notices button 4097. In some embodiments, products 4080, 4082, 4084, and 4086 along with warranty 4088, 4090, 4092, and 4094 are each buttons that when engaged by a user provide information about the product or the warranty that's button is engaged. The manage button 4096 when engaged by a user provides a user the ability to manage product and warranty data. In some embodiments, the notices button 4097 when engaged by a user provides a user the ability to manage notices related to a product or a warranty. A graphic user interface 4078 is engaged by a user via one or more of a touch screen, stylus, mouse, or keyboard.

FIG. 5 shows an embodiment of a graphic user interface 5078 of an integrated electronic warranty platform that is provided to a consumer. As shown a graphic user interface 5078 provides a claim button 5098, a product button 5100, an extend button 5108, and an offers button 5110, wherein engaging the product button 5100 displays a manufacturer button 5102, a seller button 5104, and an attorney button 5106. Engaging the buttons of the graphic user interface 5078 by the consumer provides the user access to features as described herein in response to engaging a specific button associated with the feature. For example, claim button 5098 initiates a warranty claim through the integrated electronic warranty system when engaged. For example, the offers button 5110 displays advertisements to the consumer.

### Integrated Electronic Warranty Platform Features

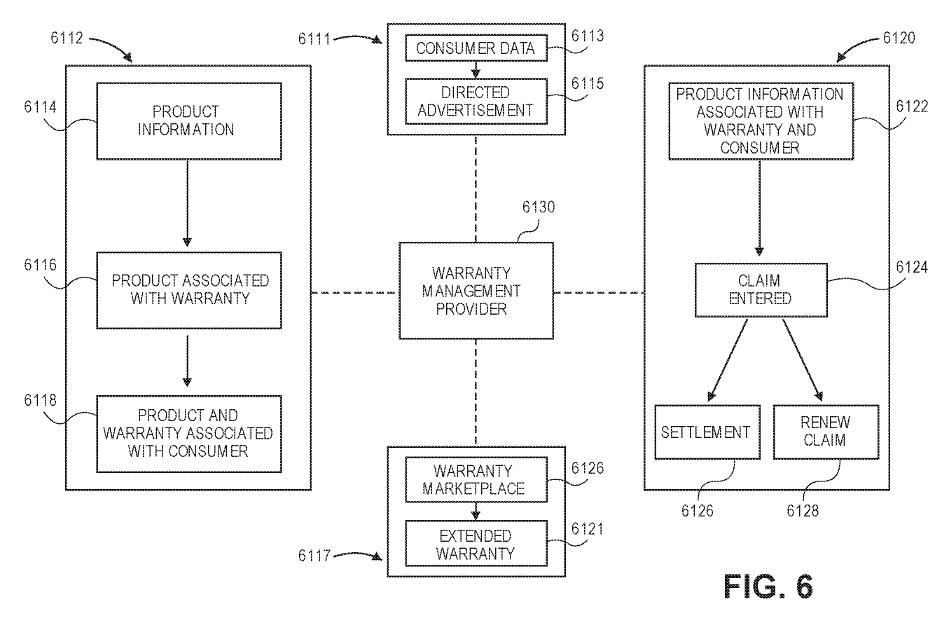

FIG. 6 shows a schematic of integrated electronic warranty platform features including warranty claim settlement, directed advertisement, and an extended warranty marketplace.

### Warranty Claim Settlement

As shown, in some embodiments, a warranty claim settlement is managed through an electronic warranty management provider 6130, and includes a product side pathway 6112 and a consumer side pathway 6120. Product side pathway 6112 comprises receiving product information 6114 by the electronic warranty management provider 6130 as described herein. The product information 6114 is associated with a warranty by the electronic warranty management provider 6130, and the product and warranty are associated with a consumer 6118 by the electronic warranty management provider 6130. Consumer side pathway 6120 begins with the association of the product and warranty for which the claim is made with the consumer 6122, the claim is then entered by the consumer 6124, and either the claim is settled 6126 or the claim is renewed 6128 after the claim is not settled.

As shown, in some embodiments, a directed advertising pathway 6111 begins with the analysis of consumer data 6113 by the electronic warranty management provider 6130. In some embodiments, the consumer data 6113 is used by the electronic warranty management provider 6130 to generate directed advertisement 6115 directed to a particular consumer and is transmitted to that consumer. In some embodiments, the electronic warranty management provider 6130, transmits the consumer data 6113 to one or more of a manufacturer, seller, and electronic payment provider that use the consumer data 6113 to generate directed advertisement to a particular consumer and transmits the advertisement to the consumer.

As shown, in some embodiments, an electronic warranty management provider 6130 provides extended warranties 6117 via an extended warranty marketplace 6126 that provides offers for sale of extended warranties 6121 to the consumer.

### Electronic Warranty Generation

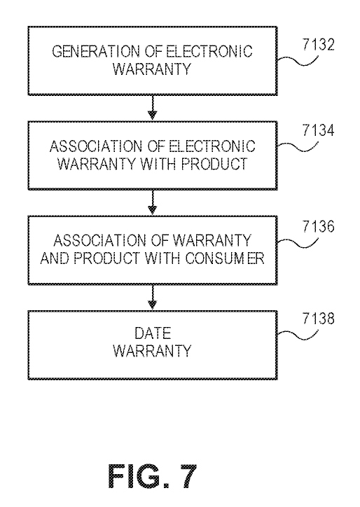

FIG. 7 shows a process for generation of an electronic warranty. In a step 7132, an electronic warranty is generated either by, for example, an electronic warranty management provider or a warrant provider. In a step 7134, the generated electronic warranty is associated with a product. In a step 7136, the product and the warranty are associated with a consumer when the product is purchased. In a step 7138, the warranty is dated with the warranty start date.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A warranty claim settlement platform, comprising:
a. a local processor configured to provide a local application to the consumer of the product, the local application comprising:
i. a software module for providing an interface for viewing an electronic warranty that is associated with an identifier of a product and an identity of the consumer, for creating a warranty claim, and for transmitting the warranty claim to the remote processor; and
b. a remote processor configured to provide a remote application, comprising:
i. a software module for receiving the identifier of the product, for receiving the identity of the consumer of the product, and for associating the electronic warranty with the identifier of the product and with the identity of the consumer of the product;
ii. a software module for receiving the warranty claim from the consumer of the product, for transmitting the warranty claim to a warranty settler, and for tracking a settlement of the warranty claim by the warranty settler.

2. The platform of claim 1, wherein the identifier of the product comprises a product serial number.

3. The platform of claim 1, wherein the identity of the consumer of the product comprises one or more of the name, address, email address, and telephone number of the consumer of the product.

4. The platform of claim 3, wherein the remote application comprises a software module for receiving a transmission from a seller of the product, and wherein the identity of the consumer of the product is transmitted to the remote processor by the seller.

5. The platform of claim 3, the remote application comprises a software module for receiving a transmission from an electronic purchase provider, and wherein the identity of the consumer of the product is transmitted to the remote processor as part of a purchase by the electronic payment provider.

6. The platform of claim 1, wherein the remote application comprises a software module for generating the electronic warranty.

7. The platform of claim 6, wherein generating the electronic warranty comprises adding a warranty start date to an electronic warranty template.

8. The platform of claim 1, wherein the remote application comprises a software module for receiving the electronic warranty from a manufacturer of the product.

9. The platform of claim 1, wherein the remote application comprises a software module for generating a digital-life identity for the consumer based on one or more of a type of the product purchased by the consumer, a price of the product purchased by of the consumer, a location where the consumer owns a residence, and an income of the consumer.

10. The platform of claim 9, wherein the remote application comprises a software module for communicating the digital-life identity to one or more of the manufacturer of the product, the seller of the product, an electronic payment provider, and the consumer of the product.

11. The platform of claim 10, wherein the remote application comprises a software module for generating a directed advertisement based on the digital-life identity.

12. The platform of claim 11, wherein the local application comprises a software module for displaying the directed advertisement using the interface.

13. The platform of claim 1, wherein the local processor comprises a mobile computing device.

14. The platform of claim 1, wherein the local application comprises a software module for managing the electronic warranty using the interface.

15. The platform of claim 1, wherein the local application comprises a software module for generating the electronic warranty.

16. The platform of claim 15, wherein the electronic warranty is generated using a digital scanner to convert a printed warranty to the electronic warranty.

17. The platform of claim 15, wherein the electronic warranty is generated using a digital camera to convert a printed warranty to the electronic warranty.

18. The platform of claim 1, wherein local application comprises a software module for generating an identifier of the product.

19. The platform of claim 18, wherein the identifier of the product is generated using a barcode reader to read a barcode associated with the product.

20. The platform of claim 1, wherein the remote application comprises a software module for generating an electronic extended warranty marketplace, and wherein the local application comprises a software module for purchasing an extended warranty from the electronic extended warranty marketplace using the interface.
